(19) United States
(12) Patent Application Publication
(10) Pub. No.: US 2017/0242980 A1
(43) Pub. Date: Aug. 24, 2017

(54) ELECTRONIC WRITABLE MEMORY DEVICES FOR PATIENT SAMPLE MANAGEMENT

(71) Applicant: Q Squared Solutions Holdings LLC, Morrisville, NC (US)

(72) Inventor: Piers Barrington, Austin, TX (US)

(21) Appl. No.: 15/435,394

(22) Filed: Feb. 17, 2017

Related U.S. Application Data
(60) Provisional application No. 62/296,977, filed on Feb. 18, 2016.

(51) Int. Cl. G06F 19/00

(52) U.S. Cl. CPC G06F 19/366; G06F 19/363; G06F 19/3406

(57) ABSTRACT

One example system includes one or more sample containers, each of the sample containers defining an interior cavity and an opening providing access to the interior cavity; one or more electronic writable memories, each electronic writeable memory coupled to one of the sample containers, each electronic writable memory configured to wirelessly receive information from a computing device and to store the received information; and a computing device to obtain sample information associated with a biological sample deposited within one of the sample containers; transmit the sample information to the wireless proximity communications device; and transmit a command to the wireless proximity communication device to store the sample information on one of the electronic writable memories.

### CROSS-REFERENCE TO RELATED APPLICATIONS

This application claims priority to U.S. Provisional Patent Application No. 62/296,977, filed Feb. 18, 2016, entitled “Electronic Writable Memory Devices for Patient Sample Management,” the entirety of which is hereby incorporated by reference.

### FIELD

The present disclosure relates generally to managing patient samples, and more particularly, although not necessarily exclusively, to writable devices for managing the collection and transport of patient samples.

### BACKGROUND

Patient samples may be collected and transported between locations for a variety of reasons. For example, typical clinical trials may involve retaining the services of one or more investigators, such as medical providers or doctors, located at one or more investigative sites to administer a drug or medical treatment to patients and to obtain and supply data on such patients during or after treatment. During a clinical trial, a laboratory may ship sample kits to the investigative sites in the clinical trial. The sample kits may include a set of containers (e.g., tubes, vials, etc.) for collecting specific samples from patients participating in the clinical trial. The laboratory may include, with the shipment, requisition forms corresponding to each kit that may include instructions for collecting the samples for the kit. The investigator or a staff member may fill in information about the samples drawn for the kit, including patient information corresponding to the patients, and ship the completed requisition forms back to the laboratory with the sample kits.

During the drawing of the samples, the investigator or staff member may not follow the instructions for properly collecting and handling the samples for the kit. Moreover, during the shipping and further handling of the samples, the requisition form containing information corresponding to the samples may be damaged or separated from the samples.

### SUMMARY

Various examples are described for electronic writable memory devices for patient sample management.

One example system includes one or more sample containers, each of the sample containers defining an interior cavity and an opening providing access to the interior cavity; one or more electronic writable memories, each electronic writeable memory coupled to one of the sample containers, each electronic writable memory configured to wirelessly receive information from a computing device and to store the received information; and a computing device comprising: a non-transitory computer-readable medium; a wireless proximity communications device configured to: establish a wireless communication link with one of the electronic writable memories, read information stored on the one of the electronic writable memories, and store information on the electronic writable memory; and a processor in communication with the wireless proximity communications device and the non-transitory computer-readable medium, the processor configured to execute processor-executable program code stored in the non-transitory computer-readable medium to: obtain sample information associated with a biological sample deposited within one of the sample containers; transmit the sample information to the wireless proximity communications device; and transmit a command to the wireless proximity communication device to store the sample information on one of the electronic writable memories.

One example method includes requesting, by a computing device comprising a wireless proximity communications device, sample information associated with a biological sample deposited within a sample container, the sample container having an electronic writable memory configured to wirelessly receive information from a computing device and to store the received information; receiving, in response to the request, the sample information; moving the computing device proximate to the electronic writable memory and establishing a communications link between the computing device and the electronic writable memory; transmitting, via the communications link, the sample information to the electronic writable memory; and storing the sample information on the electronic writable memory.

One example patient sample container comprises a biological sample container defining an interior cavity and an opening providing access to the interior cavity; and an electronic writable memory coupled to the sample container, the electronic writable memory configured to wirelessly receive information from a remote computing device and to store the received information.

One example method includes receiving, by a computing device comprising a wireless proximity communications device, a sample container containing a biological sample, the sample container having an electronic writable memory configured to wirelessly receive information from a computing device and to store the received information; moving the computing device proximate to the electronic writable memory and establishing a communications link between the computing device and the electronic writable memory; receiving, via the communications link, the sample information from the electronic writable memory; and processing the biological sample based on the sample information.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 is a cross-sectional diagram depicting an example of a container for a patient sample including a writeable device according to an aspect of the present disclosure.

FIG. 2 is a block diagram depicting a system for managing patient samples using a writeable device according to an aspect of the present disclosure.

FIG. 3 is a flow chart of an example of a process for using a writeable device to manage a patient sample according to an aspect of the present disclosure.

FIG. 4 is a flow chart of a process for transmitting information between a writeable device and a computing device according to an aspect of the present disclosure.

FIG. 5 is an example of a user interface generated by the system of FIG. 2 for managing a patient sample using a writeable device according to an aspect of the present disclosure.

FIG. 6 is an example of a user interface generated by the system of FIG. 2 for reading information stored on a writeable device according to aspects of the present disclosure.

FIG. 7 is an example of a user interface generated by the system of FIG. 2 for receiving patient information according to aspects of the present disclosure.

FIG. 8 is an example of a user interface generated by the system of FIG. 2 for collecting a sample according to an aspect of the present disclosure.

FIG. 9 is an example of a user interface generated by the system of FIG. 2 for selecting a sample container having a writeable device according to an aspect of the present disclosure.

FIG. 10 is an example of a user interface generated by the system of FIG. 2 for providing instructions to collect a sample according to an aspect of the present disclosure.

FIG. 11 is a perspective diagram depicting an example of a shipping container for multiple patient samples including a powered writeable device according to an aspect of the present disclosure.

FIG. 12 is a block diagram depicting the powered writeable device of FIG. 11 according to an aspect of the present disclosure.

FIG. 13 shows an example method for employing electronic writable memory devices for patient sample management.

FIGS. 14-15 show example user interfaces for employing writable memory devices for patient sample management.

FIG. 16 shows an example method for employing electronic writable memory devices for patient sample management.

FIGS. 17-19 show example user interfaces for employing writable memory devices for patient sample management.

### DETAILED DESCRIPTION

Examples are described herein in the context of electronic writable memory devices for patient sample management. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Certain aspects and examples of the present disclosure relate to systems and methods for managing patient samples using electronic writable devices attachable to a container for the sample. In some aspects, a sample container may include, or have affixed to it, an electronic writable device that may be used to store information related to the sample container or a sample within the sample container. In additional aspects, a computing device may include a coupling device for establishing a transmission link with the electronic writable device when the computing device is in close proximity to the electronic writable device. The computing device may be configured to write information to the electronic writable device and read information written to the electronic writable device via the transmission link.

In one illustrative example, a sample may be taken and stored in a test tube including a near field communication (“NFC”) tag as an electronic writable device on which information may be read and stored. Once the test tube has been sealed, a user may enter information about the sample into a computer device and use the computer device to wirelessly write the information to the NFC tag. Subsequently, the test tube may be placed in a shipping container and shipped to a contract research organization (“CRO”), laboratory, or other entity. A user at the receiving entity (e.g., the CRO) may use a computer device to read the information from the NFC tag. In some aspects, the information stored on the NFC tag may improve the handling and shipment of such samples.

Typically, biological samples, such as those collected during the course of a clinical trial, are deposited in containers and transported, along with a requisition form, to another site, such as a laboratory for testing. The requisition form identifies each of the samples and may provide other information, such as handling, testing, processing, storage, etc. information. However, should the samples become separated from the requisition form, it may not be possible to determine what the samples are or what is to be done with them. Thus, they may no longer be useful, and any information to be obtained from them will be lost. By affixing an electronic writable memory to each container, and then writing to the memory information about the sample, e.g., the type of sample, the clinical trial it is associated, non-personally-identifiable information (“non-PII”) about the patient, testing or handling instructions, etc., the sample may be quickly identified using an appropriate reader and handled appropriately.

In other aspects, the information stored on the NFC tag may allow the receiving entity to create a replacement requisition form, if the original is lost, or is not provided at all. In additional or alternative aspects, the user may also use the information extracted from the NFC tag and store it in a database for an associated clinical trial.

Using an electronic writable device affixed to a sample container, according to aspects of the present disclosure, where information about a sample contained in the container is physically tied to the sample via the electronic writable device, may effectively eliminate a risk that a sample may be separated from information that identifies the sample. Further, the information may be readily accessible by any computing device having the appropriate hardware for reading information from the electronic writable device and does not require access to a proprietary database for interpreting the information for identification.

Still further, electronic writable devices according to aspects of the present disclosure may allow the samples to be managed in a manner that safeguards the quality of the samples throughout the collection and shipping process. For example, the ability to write sample information, such as collection time stamps, non-PII patient information, or shipping conditions, to the device may allow an investigator or laboratory to ensure that the samples are properly drawn and handled in a manner that guarantees that the samples remain viable.

These illustrative examples are given to introduce the reader to the general subject matter discussed here and are not intended to limit the scope of the disclosed concepts. The following sections describe various additional aspects and examples with reference to the drawings in which like numerals indicate like elements, and directional descriptions are used to describe the illustrative examples but, like the illustrative examples, should not be used to limit the present disclosure. The various figures described below depict examples of implementations for the present disclosure, but should not be used to limit the present disclosure.

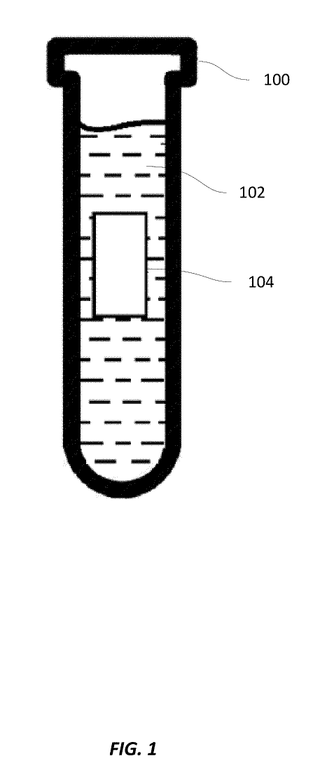

FIG. 1 depicts a container 100 for a patient sample 102 according to an aspect of the present disclosure. The container 100 may include any device capable of receiving and containing solid or fluid materials. In some aspects, the container 100 may define an opening for receiving the sample 102. The container 100 may also include a cap or other enclosure device for preventing the sample 102 from departing from the container 100 through the opening, or for preventing contamination of the sample. Non-limiting examples of the container 100 may include a tube, a vial, a bottle, a jar, a beaker, a bag, a slide, and a canister. In some aspects, the material of the container 100 may also have properties sufficient to prevent the sample 102 from departing the container 100 during transport of the sample. In some aspects, the material of the container 100 may include an insulating material that may regulate or retain a temperature or range of temperatures within the container 100 to prevent the sample 102 within the container 100 from rising above or falling below a certain temperature. Non-limiting examples of materials that may be used for the container 100 include glass, plastic, metal, extruded polystyrene foam, or a combination thereof. The sample 102 may be any biological material associated with a patient. In some aspects, the sample 102 may include bodily fluid or other bodily discharge extracted from the patient. In additional aspects, the sample may also include a material containing the body fluid extracted from the patient (e.g., a cotton swab). Non-limiting examples of the sample 102 may include blood, plasma, saliva, skin cells, stool, biopsy tissue, or hair follicles.

An electronic writable device may be attached to the container 100. In some examples, the electronic writable device may include an NFC tag 104. The NFC tag 104 may be a device capable of wirelessly communicatively coupling to another electronic device having a compatible coupling device (e.g., an NFC reader or NFC writer) that is positioned proximate (e.g., within 1-4 inches) with the NFC tag 104. In the context of this disclosure, “proximate” refers to a computing device being positioned sufficiently close to the electronic writable device to enable wireless communications between them. For example, a computing device may need to be within 1-4 inches of an NFC tag to enable wireless communications and thus be “proximate” to the NFC tag. For other types of electronic writable devices, e.g., radio frequency identification (“RFID”) tags, that distance may vary. In some examples, electronic writable devices may be unpowered or passive devices that obtain power radiated from the proximate computing device. Other examples may employ electronic writable memories that employ a battery or other power source, electronic writable memories in communication with wireless transceivers, such as Bluetooth low energy (“BLE”), wireless USB, etc. Examples employing power sources may or may not include power sources affixed to the container 100. For example, an electronic writable device may instead provide one or more pins, tabs, or contacts for temporarily providing electric power to the transceiver or electronic writable memory.

Further, in some examples, the electronic writable device may be a secure electronic writable device. For example, the electronic writable device may encrypt data stored by the device, or it may require authentication or other information from a computing device attempting to communicate with it. In this example, the NFC tag 104 may be a secure NFC tag, however, other examples of secure electronic writable devices may be employed.

In some aspects, a coupling device may automatically detect the electronic writable device, e.g., NFC tag 104, and transmit information to or receive information from the NFC tag 104 wirelessly. In some aspects, the NFC tag 104 may include a side having adhesive to allow the NFC tag 104 to be manually affixed to the container 100. In other aspects, the NFC tag 104 may be embedded in the container 100. Although the NFC tag 104 in FIG. 1 is shown as attached to a side portion of the container 100, the NFC tag 104 may be attached to any portion of the container 100, including a cap (not shown), without departing from the scope of the present disclosure. In addition, though the NFC tag 104 is described herein, any electronic writable device capable of storing information corresponding to the sample container 100 or the sample 102 and attachable to or otherwise included with the sample container 100 may be used without departing from the scope of the present disclosure.

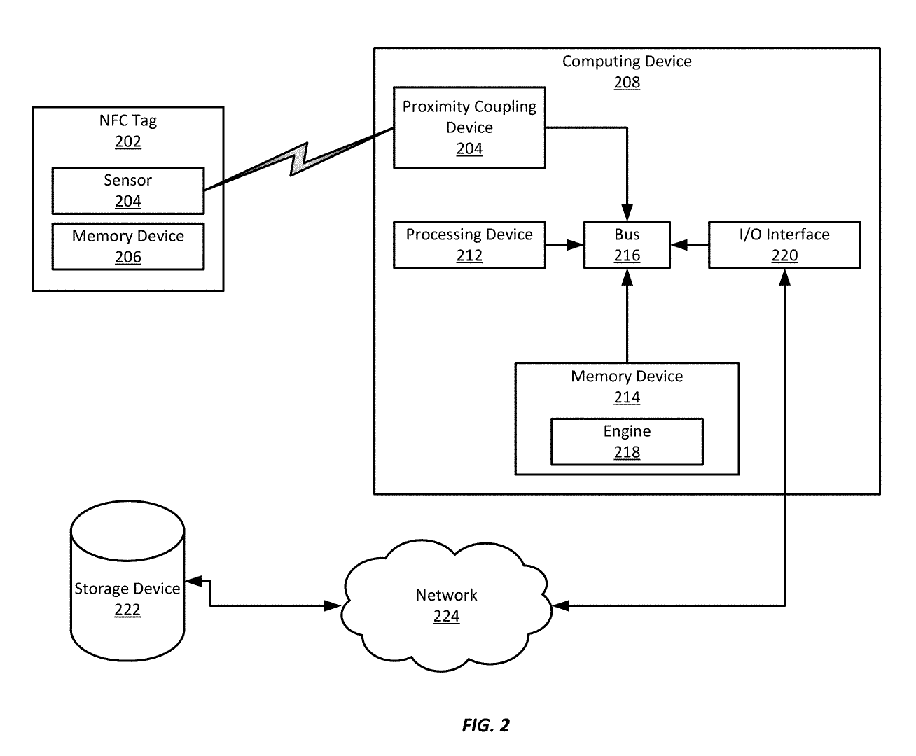

FIG. 2 depicts an example of a system 200 for managing patient samples according to an aspect of the present disclosure. In this example, the system 200 includes an NFC tag 202, though in other examples, other suitable writable devices may be employed, such as a radio-frequency identification device (“RFID”). In some aspects, the NFC tag 202 may represent the electronic writable device, NFC tag 104, described in FIG. 1. The NFC tag 202 in this example includes a sensor 204 capable of wirelessly detecting a coupling device implementing a compatible networking technology for coupling the NFC tag 202 to an electronic host device housing the coupling device. In some aspects, the NFC tag 202 and the sensor 204 may be complaint with international standards and transmission protocols for contactless integrated circuits (e.g., ISO/IEC 14443, ISO/IEC 18092, ISO/IEC 21481).

The NFC tag 202 in this example also includes a memory device 206. The memory device 206 may be a storage device integrated into the NFC tag 202 to store information corresponding to a sample or patient. The memory device may include a capacity to store identification information and sample information corresponding to the patient, the sample, or the sample container. In some aspects, the sample information may be blinded or de-identified, as necessary, such that it does not constitute protected health information, such as PII. Sample information may include, but is not limited to, time stamps corresponding to the times a sample was drawn or processed, instructions for drawing and handling a sample, instructions for testing or other additional processing for the sample, discarding the sample, patient information corresponding to the sample, test results for the sample, etc. In some aspects, the memory device 206 may include a memory size of between 64 and 924 bytes. In other aspects, the memory device 206 may include a memory size up to and exceeding 4000 bytes. The memory size of the memory device 206 may not correspond to the physical size of the NFC tag 202, allowing NFC tags 202 having a large amount of memory to be attachable to a sample container (e.g., container 100 of FIG. 1). In some aspects, the memory device 206 may allow information to be written, or encoded, onto the NFC tag 202. The memory device 206 may be encoded and re-encoded multiple times to modify, add, or delete information to or from the NFC tag 202. In some aspects, the NFC tag 202 may be locked to prevent additional modifications of the information stored in the memory device 206. In some aspects, locking the NFC tag 202 may be permanent. In other aspects, locking the NFC tag 202 may allow the information stored in the memory device 206 to be modified in only certain instances (e.g., by a specific user).

The system 200 also includes a computing device 208. The computing device may be any device that can process data and execute a set of instructions. Non-limiting examples of the computing device 208 may be a laptop, mobile phone, desktop computer, personal digital assistant, tablet, or wearable device. The computing device 208 may be wirelessly coupled to the NFC tag 202 via a proximity coupling device 210. The proximity coupling device 210 may include a transmitter or transceiver that can read, detect, and communicatively couple to the sensor 204 of the NFC tag 202. The proximity coupling device 210 may implement communication and transmission protocols to detect the NFC tag 202 when the NFC tag 202 is proximate to the computing device 208. In some aspects, the proximity coupling device 210 may emit an electromagnetic field that provides power to the NFC tag 202 by electromagnetic inductivity.

The computing device 208 may also include a processing device 212 and a memory device 214. In some aspects, the memory device 214 may include a tangible computer-readable memory on which computer-programming code may be stored. The processing device 212 may execute the code stored in the memory device 214 by communication via a bus 216 to cause the computing device 208 to initiate data transmission between the computing device 208 and the NFC tag 202. Examples of the processing device 212 may include a microprocessor, an application-specific integrated circuit (“ASIC”), a state machine, or other suitable process. The processing device 212 may include one processor or any number of processors. The memory device 214 may be any non-transitory computer-readable medium configured for tangibly embodying code and may include electronic, magnetic, or optical devices. Non-limiting examples of the memory device may include random access memory (“RAM”), read-only memory (“ROM”), a floppy disk, a compact disc, a recording device, a magnetic disk, an ASIC, a configured processor, or other suitable storage device.

In some aspects, instructions may be stored in the memory device 214 as executable code. The instructions may include processor-specific instructions generated by a compiler or an interpreter from code written in any suitable computer-programming language. The instructions may include an application, such an engine 218, that, when executed by the processor, may cause the computing device 208: to transmit data or commands between the NFC tag 202 and the computing device 208, to transmit data between the computing device and other electronic devices coupled to the computing device 208 via an input/output (I/O) interface 220, and to generate one or more user interfaces to allow such data transmissions. In some aspects, the memory device 214 may also include storage space (e.g., a data store) in which content and data may be stored. Although only one computing device 208 is shown in FIG. 2, the system 200 may include multiple computing devices. The engine 218 may be included in a memory device on each computing device in the system 200.

The I/O interface 220 may allow communication with other components, such as a storage device 222, via a network 224. In some aspects, the network 224 may be a wired network for transmitting data. In other aspects, the network 224 may be a wireless network. In some aspects, the storage device 222 may be a remote computing device in communication with a database for storing information related to a clinical trial or other medical treatment and management of samples for the medical treatment. In some aspects, the storage device 222 may represent a single database. In other aspects, the storage device 222 may represent multiple databases. The storage device 222 may be accessible via the network 224 by multiple computing devices within and external to the system 200. In some aspects, the storage device 222 may store information in a manner that associates all or a portion of the stored information. For example, the storage device 222 may be configured to store information corresponding to an identification of a sample container having an NFC tag 202. The storage device 222 may be configured to receive additional information (e.g., patient information, sample information) via the network 224 or other means and store the additional information in the same folder, or with a marker or other indicator, associating the additional information with the identification information.

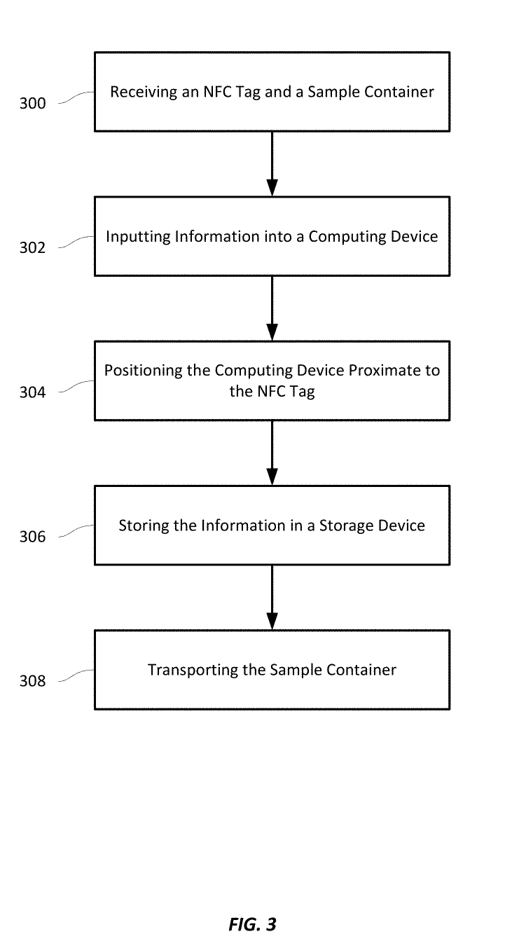

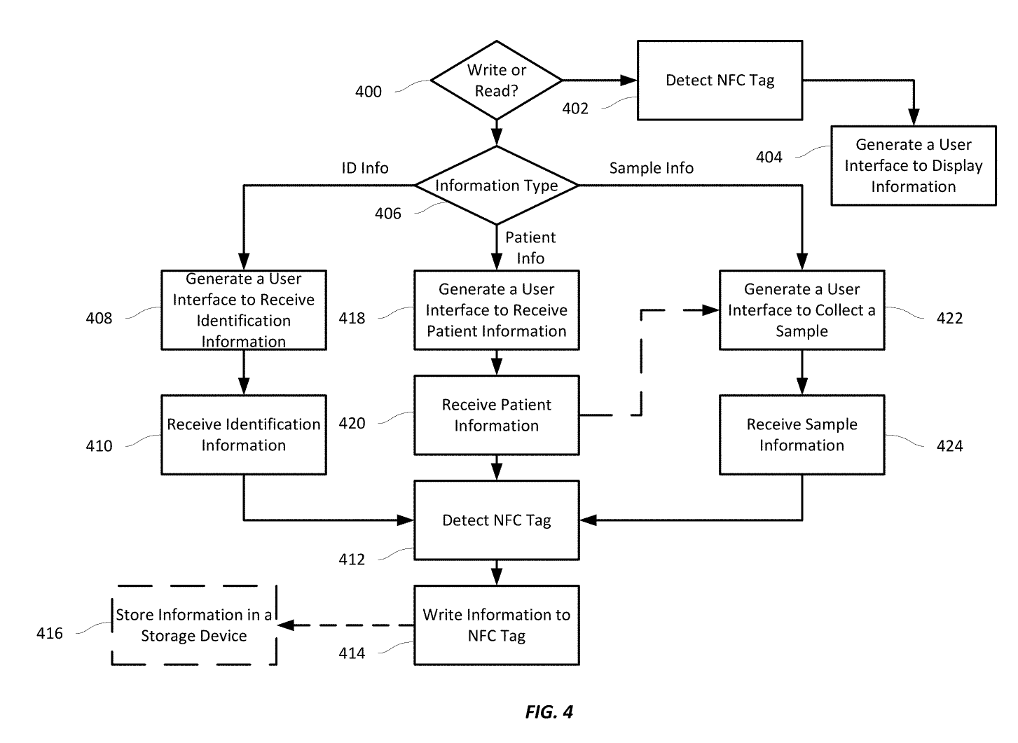

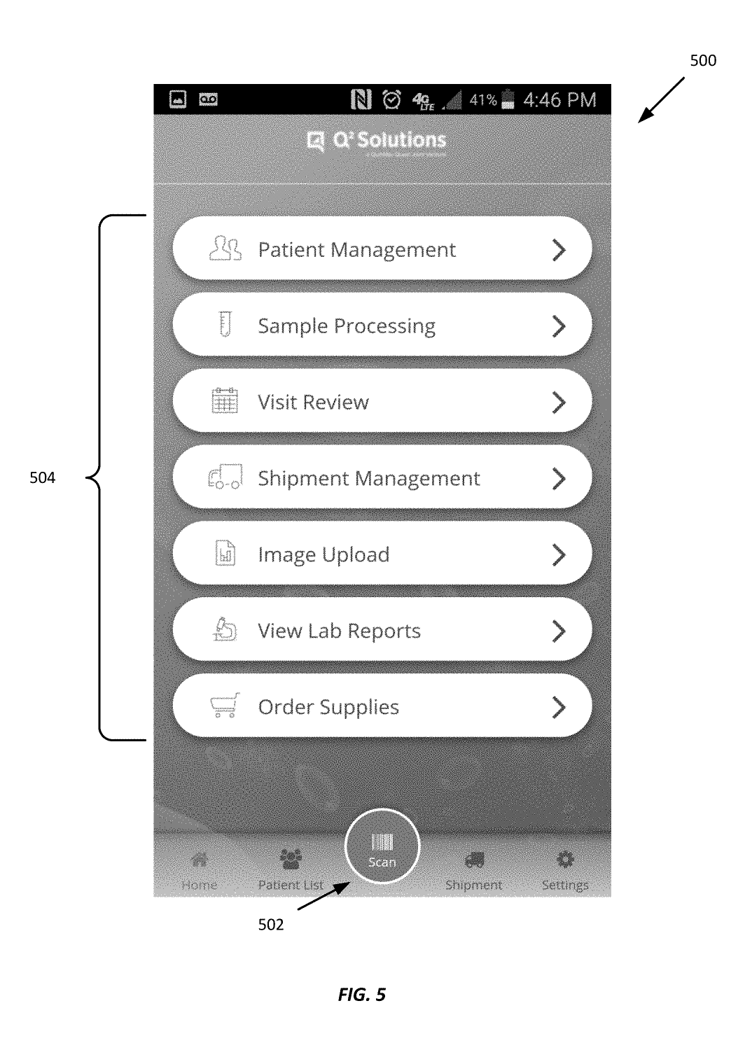

FIGS. 3 and 4 are flow charts that depict processes using writable devices for managing patient samples according to some aspects of the present disclosure. The processes are described with reference to the system implementation shown in FIG. 2 and the user interfaces shown in FIGS. 5-8, unless otherwise indicated, though other implementations are possible without departing from the scope of the present disclosure.

FIG. 3 is a flow chart of a process for transferring patient sample information to an electronic writable device according to an aspect of the present disclosure. The process is described with respect to the components of FIGS. 1 and 2, unless otherwise indicated, although other implementations are possible without departing from the scope of the present disclosure. Further, while the method shown in FIG. 3 is discussed with respect to NFC tags, it should be understood that examples according to this disclosure may employ any suitable electronic writable device.

In block 300, a sample container 100 and an NFC tag 202 are received. In some aspects, the NFC tag 202 may be received in a collection of NFC tags (e.g., a roll of tags) that may include an adhesive backing or other means for affixing the NFC tag to the sample container 100. In this example, the NFC tag 202 is affixed to the cap or seal on the container, though in other examples, the NFC tag 202 may be affixed to any suitable portion of the container. The NFC tag 202 may be affixed to the sample container 100 by a technician, staff member, or other person receiving the NFC tag 202. In other aspects, the NFC tag 202 may be received affixed to the sample container 100. In further aspects, the NFC tag 202 may be embedded in the sample container and may be received by receiving the sample container 100 having the NFC tag 202.

In block 302, information may be entered into a computing device 208 to be written onto the NFC tag 202. In some aspects, the information may include identification information (e.g., a sample identifier for identifying and/or differentiating the sample container, such as a uniform resource locator (“URL”) for identifying to whom the sample container belongs). In other aspects, the information may include information corresponding to the patient sample, the sample container, or the patient. In some aspects, the engine 218 may cause the computing device 208 to generate a user interface allowing the technician or another user to input or select the information to be written onto the NFC tag 202. The user interface may correspond to an application running on the computing device 208. In some aspects, the information may be entered into the computing device 208 by a technician at the laboratory. For example, the technician may enter a unique set of characters as identification information that may be subsequently used to identify the sample container 100 having the NFC tag 202 affixed. In other aspects, the information may be entered into the computing device 208 by an investigator at a clinical trial site. For example, the investigator may enter patient information corresponding to the sample drawn and stored in the sample container 100. In another example, the investigator may enter information corresponding to the draw or handling of the sample stored in the sample container 100 (e.g., confirming that the sample was centrifuged).

In block 304, the computing device 208 is positioned proximate to the NFC tag 202 to allow them to establish a communication link. For example, where the computing device 208 is a handheld electronic device, the computing device 208 may be placed within approximately six inches of the NFC tag 202 to establish the communication link between the sensor 204 of the NFC tag 202 and the proximity coupling device 210 of the computing device 208. In another example, the sample container 100 having the NFC tag 202 may be positioned proximate to the computing device 208 to establish the communication link. In some aspects, establishing the communication link based on the proximity of the computing device 208 and the NFC tag 202 may cause the information to be automatically written onto the NFC tag 202. In other aspects, the technician or investigator may selectively cause the information to be written onto the NFC tag 202. For example, the engine 218 of the computing device 208 may generate a user interface having a selection option to actuate the transfer of the information to the NFC tag 202 in response to a selection by the user of the computing device 208.

In block 306, the information may optionally be stored in the storage device 222. In some aspects, the user of the computing device 208 may cause the computing device 208 to store the information as data in the storage device 222. In some aspects, the engine 218 may generate a user interface including a selection option for causing the information to be transmitted to the storage device 222. In additional and alternative aspects, the user interface generated may include the selection option for causing the sample identifier to be transmitted to the storage device 222. In other aspects, the engine 218 may cause the computing device 208 to automatically store the information in the storage device 222 simultaneously with or in response to successfully transmitting the information to the NFC tag 202.

In block 308, sample container 100 may optionally be transported. In some aspects, the sample container 100 having the NFC tag 202 may be transported to a clinical trial or other collection site by the technician for collecting a sample and sample information. In some examples, the sample container may be shipped by the technician of the laboratory to a clinical trial site, or other collection site, with additional sample containers also having NFC tags and forming a sample kit. The sample kit may be received by the clinical trial site and used to collect a set of samples in the containers of the sample kit. In some aspects, the sample may include a blood sample or another sample of interest for a clinical trial. In additional and alternative aspects, the investigator may transport the sample container 100 including a collected sample. In one example, the investigator may receive instructions via a requisition form or via instructions stored in the memory device 206 of the NFC tag 202 to scan the NFC tag 202 (or communicatively couple the investigator's computing device to the NFC tag 202 by placing the computing device in close proximity of the NFC tag 202) upon completing a draw of the sample to the sample container having the NFC tag. In some aspects, the NFC tag 202 may record a timestamp corresponding to the time of the investigator's scan of the NFC tag 202 as sample information in the memory device 206. In additional and alternative aspects, the investigator may also record patient information or other information corresponding to the sample in the memory device 206 of the NFC tag 202 as sample information. Upon completing a draw of the required samples for the sample kit, the sample kit including the NFC tag may be shipped back to the laboratory where the NFC tag 202 is received having the sample information corresponding to the sample housed in the sample container, as described in block 310.

FIG. 4 is a flow chart of one or more processes for managing patient samples using an electronic writable device according to an aspect of the present disclosure. Although the flow chart illustrates managing patient samples using the electronic writable device as a single process, certain steps described in the flow chart may be performed in separate processes or sub-processes for managing the patient samples. Similarly, although the flow chart describes a certain order of performing the steps, the order of performing the steps in each process or sub-process may vary without departing from the scope of the present disclosure. The processes of FIG. 4 are described with respect to the components of FIGS. 1 and 2 and certain examples of user interfaces generated by the system of FIG. 2, though other implementations are possible without departing from the scope of the present disclosure.

In block 400, the computing device 208 determines whether to write information to the NFC tag 202 or to read information from the NFC tag 202. In some aspects, the computing device 208 may determine whether to read or write the information in response to a selection by a user. In one example, the engine 218 may cause the computing device 208 to execute an application that may generate a user interface including selection options for allowing a user of the computing device 208 to select whether to read information from the NFC tag 202 or to write information to the NFC tag 202.

FIG. 5 is an example of a user interface 500 that may be generated by the engine 218 to allow the user to select whether to read or write information. The user interface 500 includes selection options 502, 504 corresponding to writing information to the NFC tag 202 and reading information from the NFC tag 202, respectively. For example, the selection option 502 is labeled “Scan” and, in response to a selection by the user, may allow the user to view information stored on the NFC tag 202. The user interface 500 may include additional selection options 504 to write new information or modified information to the NFC tag 202.

Returning to FIG. 4, in block 402, the engine 218 may cause the computing device 408 to detect the NFC tag 202. In some aspects, the computing device 408 may detect the NFC tag 202 in response to a selection of the selection option 502 of FIG. 5 by the user. The NFC tag 202 may be detected by the proximity coupling device 210 of the computing device 208. The NFC tag 202 may be positioned in close proximity with the computing device 408 to allow the proximity coupling device 210 to detect the NFC tag 202. Once detected, a communication link may be established between the computing device 408 and the NFC tag 202.

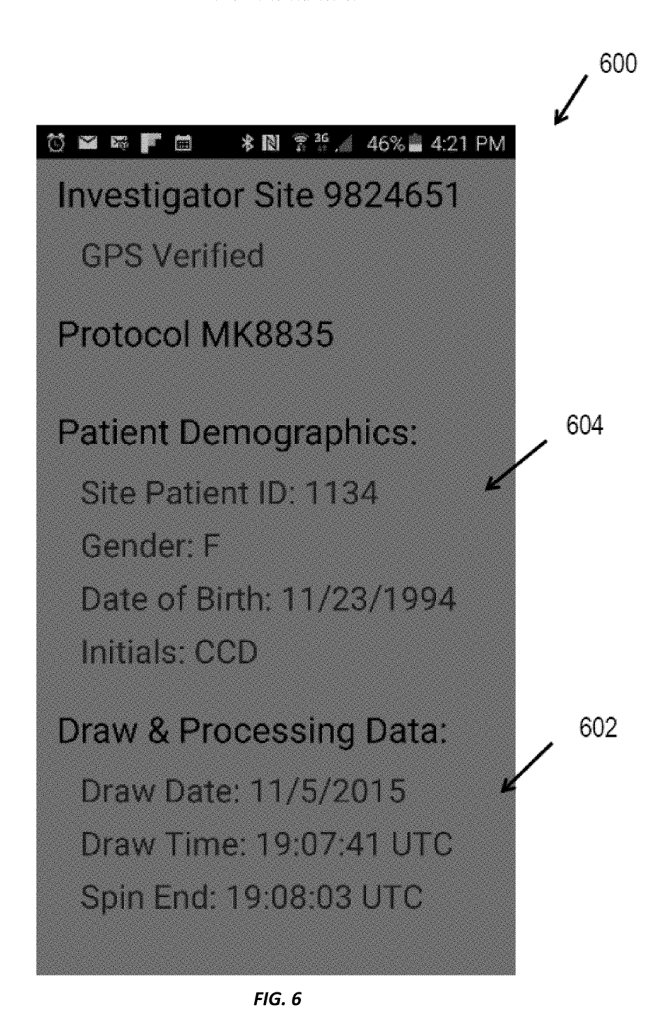

In block 404, the engine 218 may generate a user interface displaying the information stored on the NFC tag 202. FIG. 6 is a user interface 600 that may be generated by the engine 218 in response to a communication between the computing device and the NFC tag 202 according to an aspect of the present disclosure. In FIG. 6, user interface 600 includes sample information 602 in the form of time stamps associated with a draw of the sample and additional handling of the sample. For example, the “Draw Date” may indicate the date on which the sample was drawn. The “Draw Time” may indicate the time at which the sample was drawn. The “Spin End” may indicate that the time at which spinning the sample in a centrifuge ended. In some aspects, each timestamp may have been previously written to the NFC tag 202 in response to a scan of the NFC tag 202 subsequent to each step of the sample-collection instructions. In other aspects, the timestamps may indicate that the user has completed certain instructions for collecting the sample. The timestamps may be collectively stored on the NFC tag 202 subsequent to a completion of the sample collection process. The user interface 600 also includes patient information 604 corresponding to the sample. In some aspects, the patient information 804 may be stored as additional sample information. In some aspects, the patient information 804 may be previously stored information written to the NFC tag 202. The patient information 604 may be blinded or de-identified patient information.

In block 406, the engine 218 may cause the computing device 208 to determine the type of information to be written to the NFC tag 202. In some aspects, this determination may be in response to a selection of the “Update NFC” selection option 502 in FIG. 5 by the user. In some aspects, the engine 218 may generate one or more user interfaces including selection options to allow a user to select the type of information to be written to the NFC tag 202. In response to the user selection, the computing device 208 may determine the type of information to be written to the NFC tag 202 and may generate the appropriate user interfaces for collecting the information.

In block 408, the engine 218 may generate a user interface for receiving identification information. The user interface may be generated in response to a determination by the computing device 208 to write identification information to the NFC tag 202. In some aspects, the user interface may include one or more selection tools or input tools to allow a user to select or input the identification information to be written to the NFC tag 202. In other aspects, the computing device 208 may be coupled to or include a random number generator to generate the identification information.

In block 410, the engine 218 may receive the identification information. In some aspects, the computing device 208 may receive the identification information from the user based on information manually entered by the user. For example, the identification information may include a random number or code that may be associated with the sample container 100. In additional and alternative aspects, the identification information may include a URL associated with a message identifying the sample container 100 or the owner of the sample container 100. For example, the URL may include a link to a website that provides contact information for the owner of the sample container 100 in the event that the sample container 100 is separated from the requisition form or other sample containers 100 in a sample kit. In other aspects, computing device 208 may receive identification information from a random number generator. The identification information may be a random set of alphanumeric characters that may be associated with the sample container 100 for identifying the sample container 100 in the event that the sample container 100 is separated from the requisition form or the other sample containers 100 in the sample kit.

In block 412, the engine 218 may cause the computing device 208 to detect the NFC tag 202 in the same manner as described in block 402. In block 414, the computing device 412 may write the identification information to the NFC tag 202 using the communication link established between the NFC tag 202 and the proximity coupling device 210 in response to the detection of the NFC tag 202 by the computing device 208.

In some aspects, the process may include an optional step as indicated by the dashed block 416. In block 416, the engine 218 may cause the computing device 208 to optionally store the identification information in the storage device 222. In some aspects, the computing device 208 may automatically store the identification information in the storage device 222 via the network 224 simultaneously with or subsequent to transmission of the identification information to the NFC tag 202. In other aspects, the computing device 208 may store the information in the storage device 222 in response to a selection by a user of the computing device 208.

In block 418, the engine 218 may cause the computing device 208 to generate a user interface for receiving patient information. The computing device 208 may generate the user interface in response to a determination that patient information is to be written to the NFC tag 202. In some aspects, the patient information may be selected or entered by using the engine 218 via an application on a second computing device of the system 200. In some aspects, the user interface may include selection tools or input tools to allow a user to enter patient information corresponding to a new patient. In additional and alternative aspects, the user interface may include selection tools or input tools to allow the user to search for a patient having patient information previously stored in the storage device 222. In one example, the engine 218 may cause the computing device 208 to generate an additional user interface that may include a list of patient information corresponding to patients previous stored in the storage device 222.

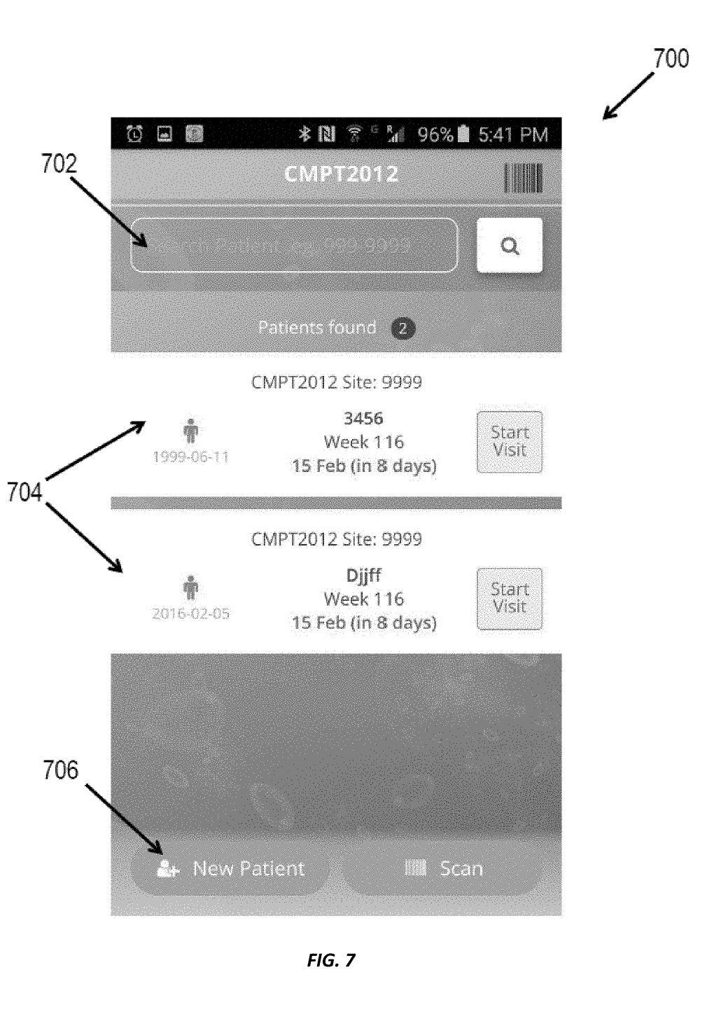

FIG. 7 is an example of a user interface 700 that may include a list of patient information corresponding to a search by the user. The user interface 700 includes an input tool 702 to allow the user to search for the patient information or to modify a search for the patient information. The user interface 700 also includes selection options 704 comprising blinded patient information corresponding to patients previously stored in the storage device 222. The selection options 704 includes patient information in the form of an investigative site where the patient receives his or her treatment (e.g., “CMPT2012 Site: 9999”), identifying information corresponding to the patient (e.g., “ ”3456,” “Djjff”), and additional information corresponding to the treatment (e.g., patient visit information, clinical trial information, etc.). The user interface 700 also includes a selection option 706 to allow new patient information to be entered.

Returning to FIG. 4, in block 420, the engine 218 may receive the patient information. In some aspects, the patient information may be received in response to a selection by the user of a selection option corresponding to the intended patient from whom a sample may be drawn (e.g., one of selection options 704 in FIG. 7). In other aspects, the patient information may be received in response to a user manually inputting the patient information using input tools on a user interface generated by the engine 218.

In blocks 412, 414, and 416, the NFC tag 202 may be detected and the patient information may be written to the NFC tag 202 and optionally stored in the storage device 222 as described with respect to the sub-process for writing identification information to the NFC tag 202. In some aspects, the patient information may be associated with the identification information in the storage device 222. For example, engine 218 may cause the computing device 208 to store the patient information in the storage device 222 linked to the identification information to indicate that samples received in the sample container 100 having the NFC tag 202 correspond to the patient associated with the patient information.

In block 422, the engine 218 may cause the computing device 208 to generate one or more user interfaces for collecting the sample. The computing device 208 may generate the user interface in response to a determination that sample information is to be written to the NFC tag 202. In some aspects, the computing device 208 may generate the user interface subsequent to identifying the patient information that will correspond to the sample to be collected.

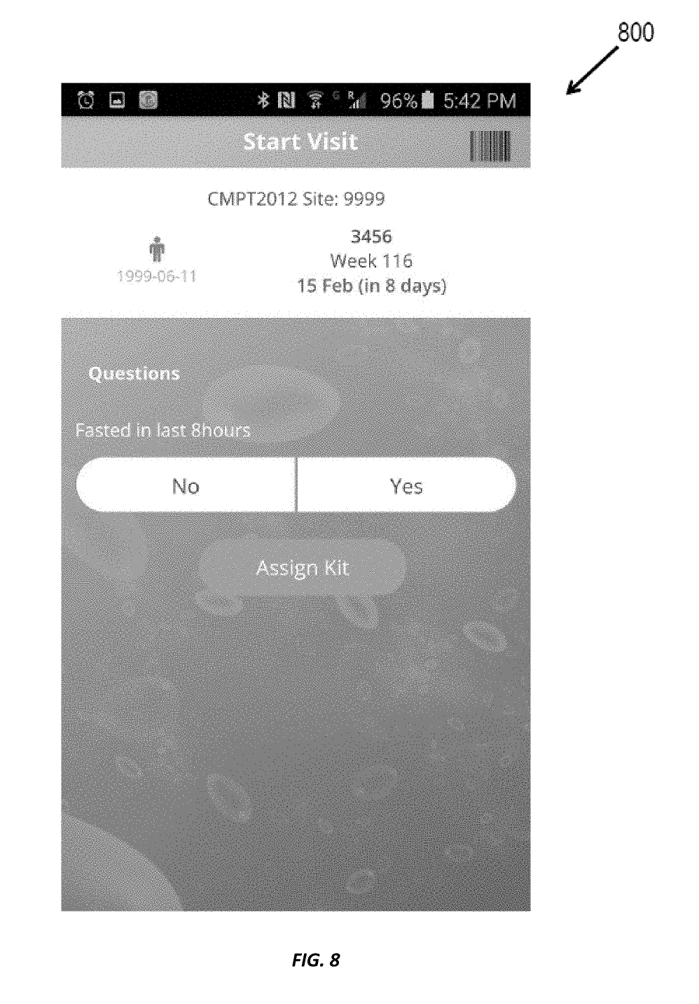

FIGS. 8-10 are examples of user interfaces that may provide instructions for collecting the sample according to some aspects of the present disclosure. FIG. 8 includes user interface 800 that may initiate the sample collection sub-process. The user interface 800 includes an example question that may be posed to the patient prior to collecting the sample. For example, the user interface 800 includes a question regarding whether the patient has fasted for an appropriate amount of time to collect the sample. In some aspects, the response to the question may be included as sample information.

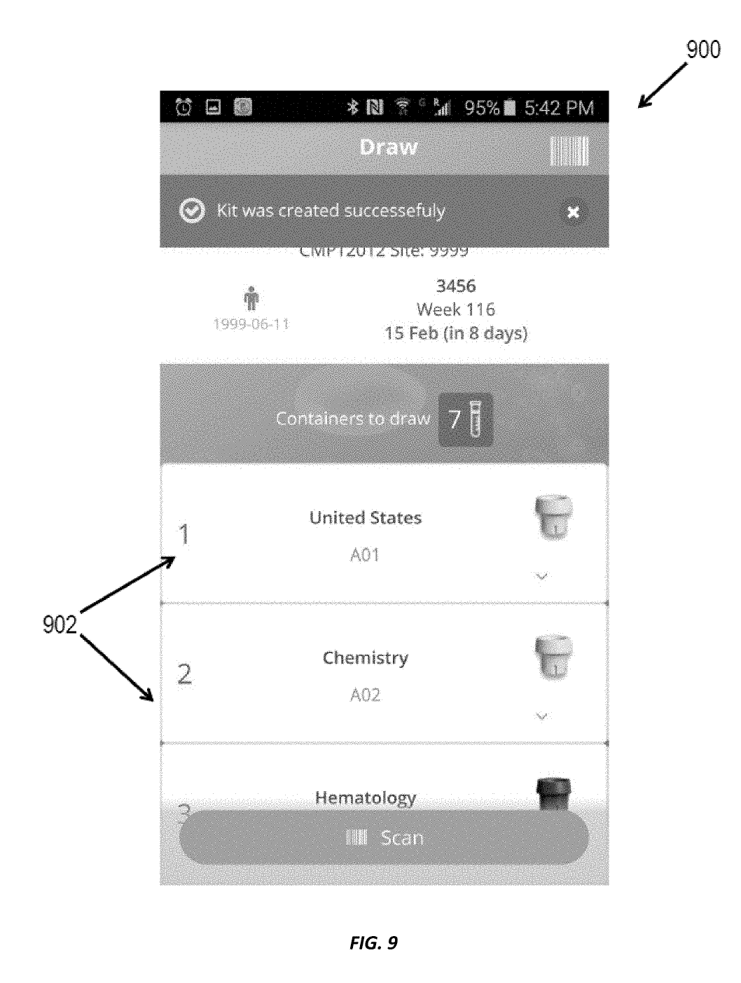

FIG. 9 is a user interface 900 including selection options 902 corresponding to each sample container 100 in a sample kit. For example, the selection option 902 including the label “A01” may correspond to a first sample container 100 in the sample kit and the selection option 902 including the label “A02” may correspond to a second sample container 100 in the sample kit. In some aspects, the user interface 900 may be generated in response to an answer to the question posed in the user interface 800 of FIG. 8.

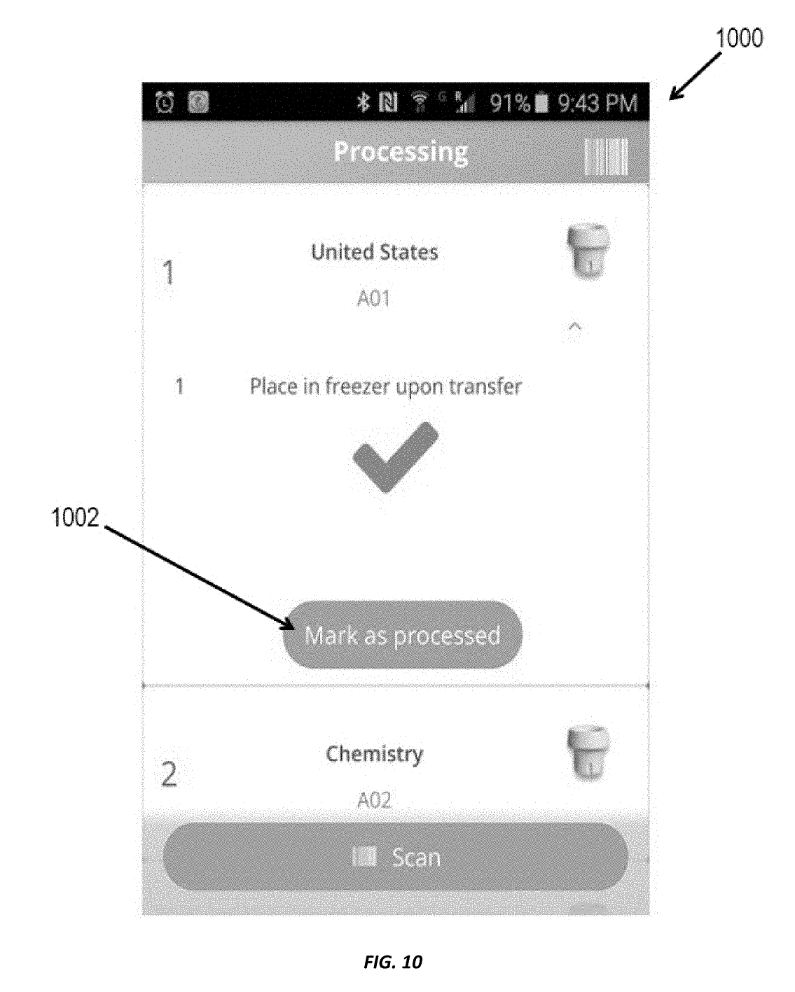

FIG. 10 is a user interface 1000 that may be generated in response to a selection of the selection option 902 labeled “A01.” The user interface 1000 includes instructions corresponding to the sample drawn for the sample container 100 having the NFC tag 202. For example, the user interface 1000 includes instructions for the sample to be placed in a freezer upon transfer of the sample. The user interface 1000 includes an additional selection option 1002 labeled “Mark as processed.” In some aspects, a user may select the selection option 1002 to indicate that the instructions have been followed. In additional aspects, the user may select the selection option 1002 to indicate that the sample has been properly drawn. In some aspects, the engine 218 may record a time associated with the selection of the selection option 1002 and generate a timestamp that may be included as sample information.

Returning to FIG. 4, in block 424, the engine 218 may receive the sample information. In blocks 412, 414, and 416, the NFC tag 202 may be detected and the sample information may be written to the NFC tag 202 and optionally stored in the storage device 222 as described with respect to the sub-process for writing identification information to the NFC tag 202. In some aspects, the sample information may be associated with the identification information and/or the patient information in the storage device 222. For example, engine 218 may cause the computing device 208 to store the sample information in the storage device 222 linked to the identification information and the patient information to indicate that the samples drawn into the sample container 100 having the NFC tag 202 correspond to the patient and sample container 100 associated with the sample information. Although the sample information collection sub-process initiated in block 422 is described as a separate sub-process than the patient information collection sub-process initiated in block 418, in some aspects, patient information and the sample information may be written to the NFC tag 202 as described in blocks 412, 414, 416 simultaneously. For example, after receiving the patient information as described in block 420, the engine 218 may cause the computing device 208 to generate the user interfaces having the instructions as described in block 422.

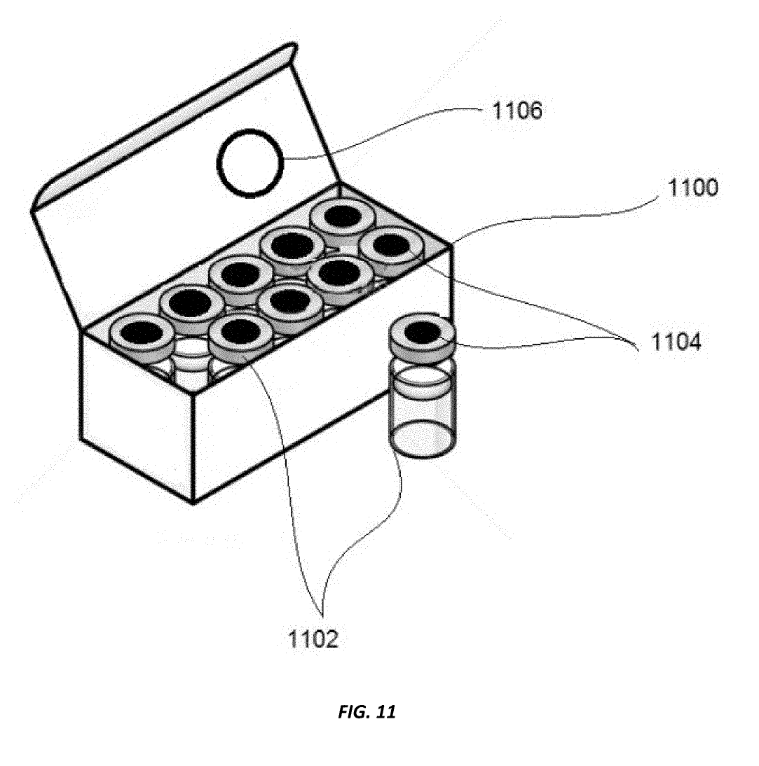

FIG. 11 is a perspective view depicting an example of a shipping container 1100 including a powered writable device that may be used to transport sample kits for a clinical trial according to an aspect of the present disclosure. In some aspects, the shipping container 1100 may be sized to securely house and transport multiple individual sample containers (e.g., sample container 100). For example, the shipping container 1100 may be sized to hold a sample kit 1102, formed by a collection of individual sample containers. In some aspects, the sample kit 1102 may correspond to a set of individual samples drawn from a single patient. In other aspects, the sample kit 1102 may represent multiples sets of samples corresponding to multiple patients. Each individual sample container may include an NFC tag 1104 that may be used to manage the individual samples as described in FIGS. 1-4. The shipping container 1100 may also include a powered NFC tag 1106 that may be affixed or otherwise included in the shipping container 1100 during shipment of the sample kit 1102. The powered NFC tag 1106 may be an electronic writable device having a power source for providing power to the NFC tag for storing information corresponding to a condition of the shipping container 1100 during shipment of the sample kit 1102.

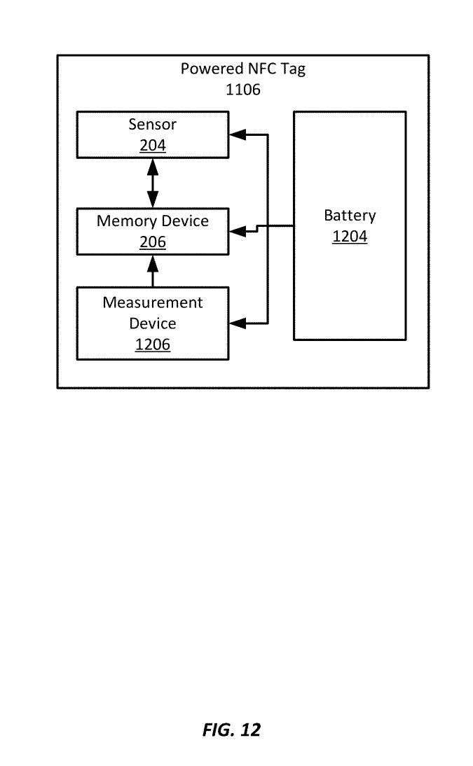

FIG. 12 is a block diagram depicting an example configuration of the powered NFC tag 1106 according to an aspect of the present disclosure. The powered NFC tag 1106 includes a sensor 1200 and a memory device 1202 operational similar to the sensor 204 and the memory device 206 of the NFC tag 202 of FIG. 2. The powered NFC tag 1106 may also include a battery 1204. In some aspects, the battery 1204 may include a power source in electrical communication with the sensor 1200 and a measurement device 1206. In some aspects, the battery 1204 may provide intermittent power to the measurement device 1206 to cause the measurement device 1206 to sense a parameter in a shipping container housing a sample kit (e.g., sample kit 1102) and store the measurement in the memory device 1202. Non-limiting examples of the measurement device 1206 may include a thermometer for sensing a temperature inside the shipping container, a hygrometer for sensing humidity inside the shipping container, and an accelerometer for measuring vibrations in or the jostling of the shipping container during shipment.

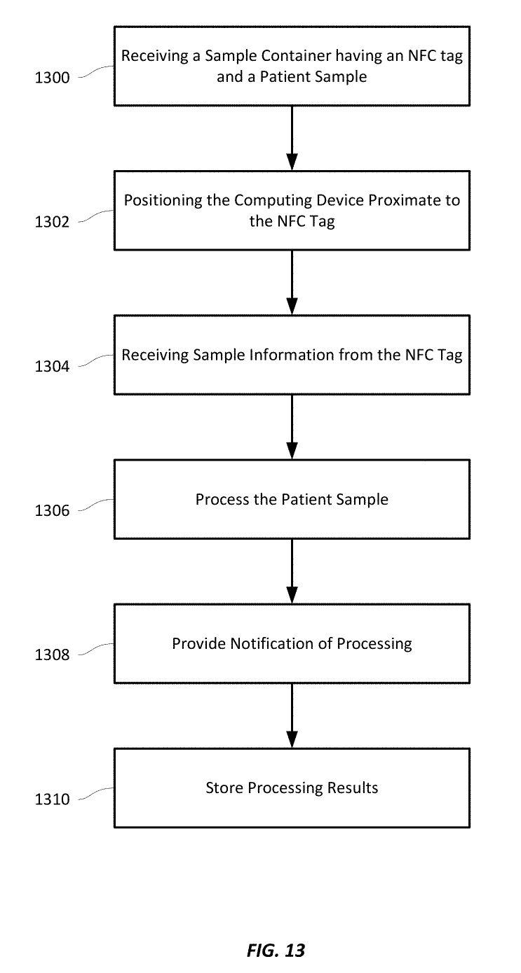

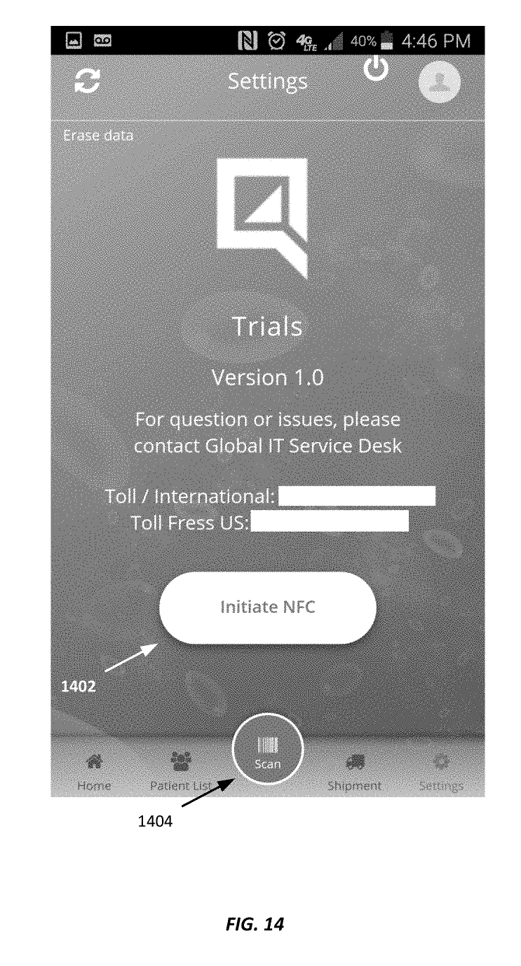

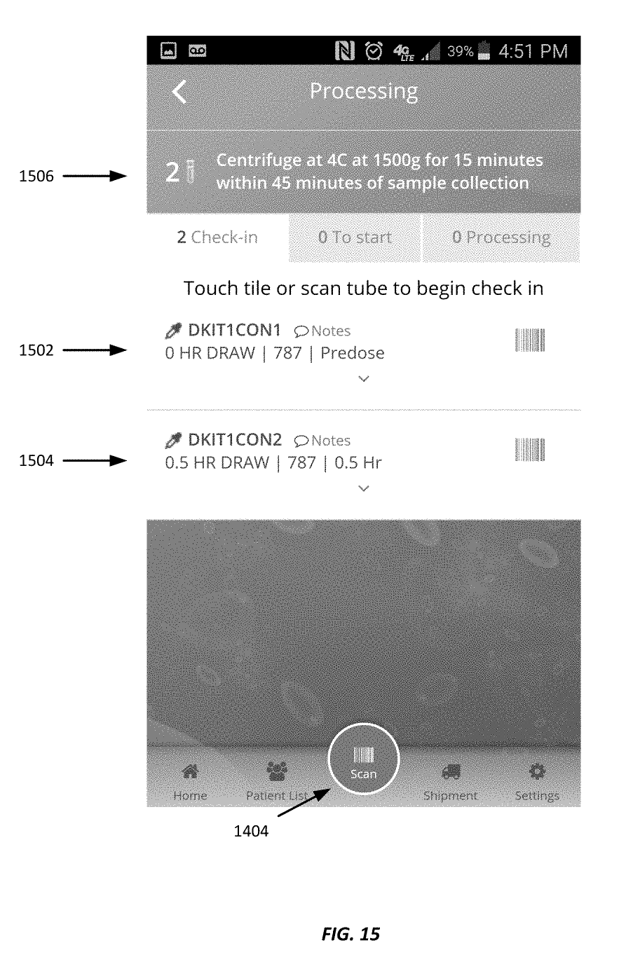

Referring now to FIG. 13, FIG. 13 shows a method for employing electronic writable memory devices for patient sample management. The method of FIG. 13 will be discussed with respect to the system shown in FIG. 2 and the screenshots shown in FIGS. 14-15; however it should be appreciated that methods according to this disclosure may be performed with any suitable system according to this disclosure.

At block 1300, a sample container having an electronic writable memory 200 and a patient sample is received. In this example, the patient sample is a biological sample from a human patient, but may be any suitable sample, including a sample from a non-human organism or a non-biological sample. Further, the sample container is hermetically sealed to prevent contamination of the biological sample and to prevent it from spilling from the container.

In this example, the sample container is received from a shipping department in a larger container having multiple sample containers arrayed within it. However, the sample may be received by obtaining it from a storage location, such as in a refrigerator or freezer, or from a non-climate-controlled storage location.

At block 1302, a computing device 208 is positioned proximate to the electronic writable memory 200. As discussed above, the computing device 208 is proximate to the electronic writable memory 200 when it is able to establish a wireless communications link with the electronic writable memory 202. In this example, the electronic writable memory 202 is an NFC tag, and therefore the computing device is proximate to the NFC tag 202 when it is brought within a few inches (e.g. 1-6 inches) or closer to the NFC tag 202. At such a range, the proximity coupling device 204 of the computing device 208 is close enough that it can radiate sufficient energy to the NFC tag 202 to activate the NFC tag 202 and send one or more commands to the NFC tag 202 to read or write information to the NFC tag's memory device 206. As can be seen in FIG. 14, a GUI provided by the computing device 208 enables a user to initiate 1402 an NFC mode and to attempt to scan 1404 any NFC tag that is in range of the computing device 208. In other examples, electronic writable memory devices may include other types of wireless communications mechanisms, which may provide greater or lesser wireless communications range. For example, a Wi-Fi-enabled electronic writable memory device may be proximate to the computing device 208 when both are in communication with each other via an intermediate network (or networks), irrespective of physical distance, or via a peer-to-peer connection.

At block 1304, the computing device 208 receives, via the communications link, sample information from the electronic writable memory. In this example, the user employs a graphical user interface to scan the NFC tag 202, such as shown in FIG. 15. In response to the user pressing the “Scan” button 1404, the computing device 208 may either establish a communications link or, if one is established, request the information stored in the NFC tag's memory 206. In response to the request for the information via the communications link, the NFC tag 202 transmits the sample information 1502-1506 stored in its memory device 206 to the computing device 208.

As discussed above, the sample information 1502-1506 may include information about the sample itself, e.g., an identification of the type of sample material, patient information (e.g., non-PII) or other source information about the sample material, storage instructions for the sample material, processing instructions for the sample materials, etc. In this example, the sample information includes processing instructions 1506 for the sample. Processing instructions may include one or more tests to be performed on the sample material, cleaning or handling instructions for the sample material, etc.

After receiving the sample information, some or all of the sample information may be displayed via a display device, such as one disposed within, or coupled to, the computing device 208. In this example, the computing device displays a GUI that identifies the types of sample information and provides user interface elements, e.g., buttons, to select a type of sample information and see additional details. A user may then select the processing instructions to obtain more information about how the sample material should be processed.

At block 1306, the sample material is processed according to the processing instructions. For example the sample material may be tested according to one or more tests prescribed for a clinical trial. In some examples, the sample material may pass through an intermediary workstation or facility for pre-processing prior to being sent for testing. Such pre-processing may include cleaning or otherwise preparing the material for testing, such as by adding a substance or substances to the sample container, or by extracting a portion of the sample material and depositing it in another sample container, which may or may not have an electronic writable device affixed to it. Still further manners of processing the sample may be employed.

At block 1308, the user may provide an input to the computing device indicating that the sample has been processed, or is being processed, according to the instructions. Such information may then be communicated to another computing device, such as a remote data store 222. Such information may provide tracking information regarding the sample, status information regarding testing, or otherwise provide information for a clinical trial, such as a number of samples processed.

At block 1310, the results of processing the sample are stored. For example, the results may be transmitted to a data store, such as data store 222, or may be stored on the NFC tag for later retrieval. For example, after processing the sample, the results may be stored on the NFC tag, and the sample container may be transported to a different workstation or facility for entry of the processing results into a data store 222 or other data repository.

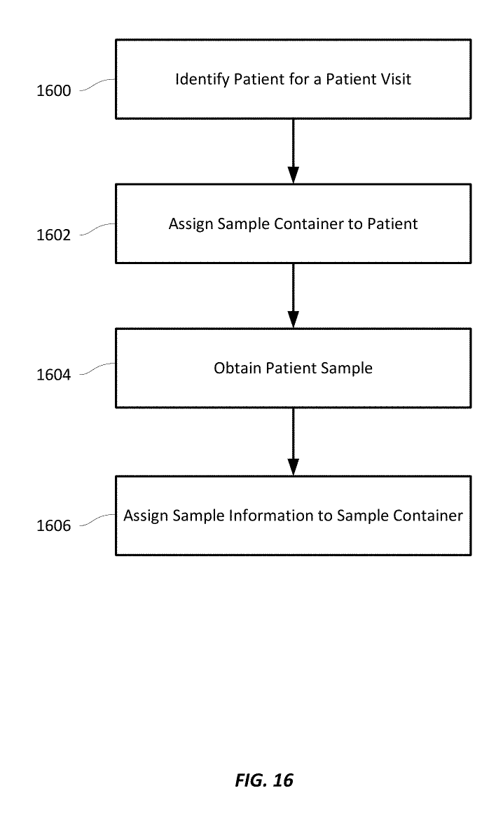

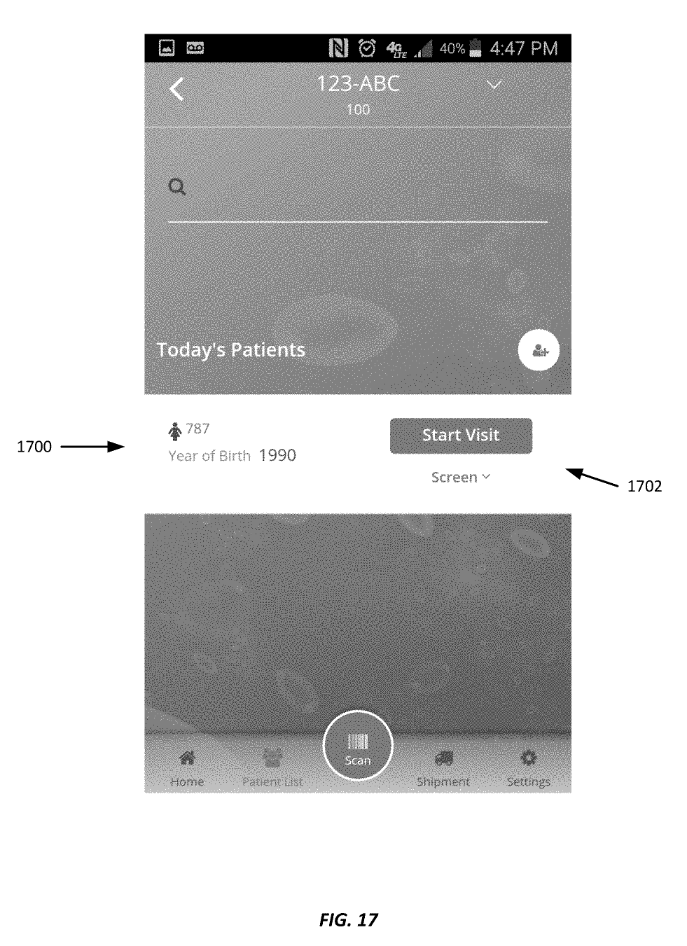

Referring now to FIG. 16, FIG. 16 shows an example method for employing electronic writable memory devices for patient sample management. The method of FIG. 16 will be discussed with respect to the system shown in FIG. 2 and the screenshots shown in FIGS. 17-19; however it should be appreciated that methods according to this disclosure may be performed with any suitable system according to this disclosure.

At block 1600, a patient is identified for a patient visit. In this example, a patient has arrived to have two samples drawn for testing, and a doctor or other medical professional uses the computing device 208 to identify the patient's visit information. In FIG. 17, an example GUI is shown that shows a patient record 1700 associated with the patient. When the patient arrives to have the samples drawn, the user can select the “Start Visit” button 1702 to being processing the patient's visit. In other examples, other GUI elements may be used instead. For example, rather than having a discrete button, the user may simply touch the patient record, e.g., patient record 1700, of interest to begin the visit.

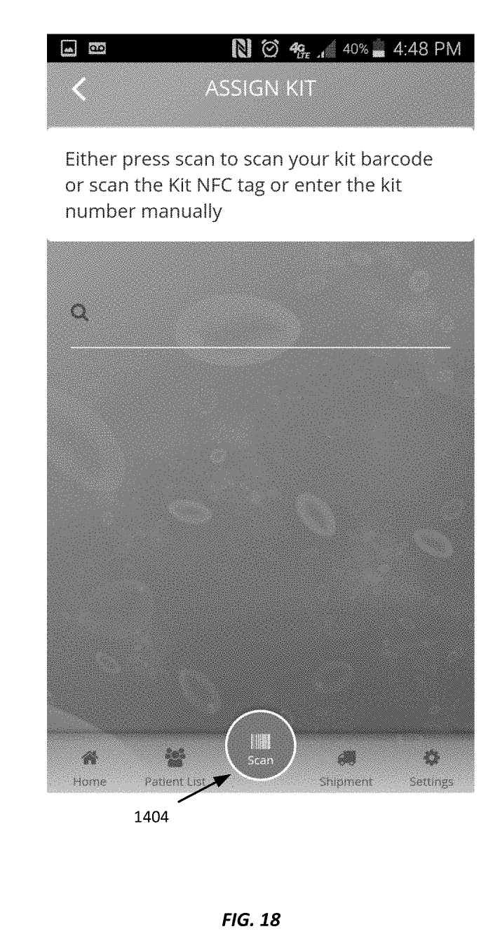

At block 1602, the doctor or medical professional obtains a sample container—two in this example—to hold patient samples. To associate the sample containers with the patient, the GUI asks the user to press the scan button 1404, shown in FIG. 18, to scan an NFC tag on the sample container to assign it to the patient. At this time, no information is written to the NFC tag, in this example; however, in some examples, patient information may be written to the NFC tag to associate the sample container to the patient.

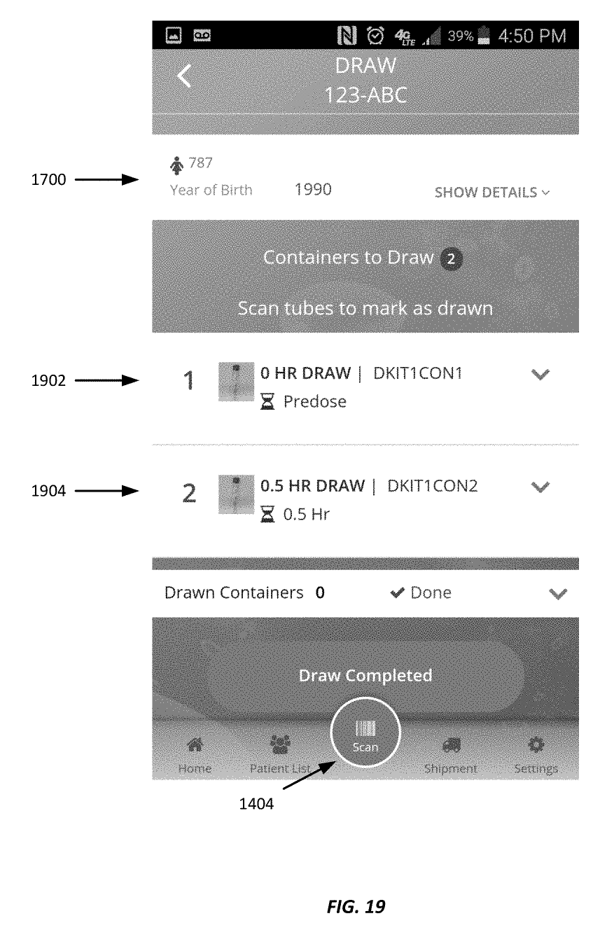

At block 1604, the doctor or medical professional obtains a patient sample. In this example, two blood samples are obtained, as shown in FIG. 19. The first blood sample 1902 is obtained prior to the patient 1700 being administered a dose of medication, and the second 1904 is obtained 30 minutes after the dose is administered. In this example, the user is able to provide an indication within the GUI when each sample is drawn by using the scan button 1404 on the respective sample container's NFC tag. The computing device 208 thus maintains an association between the sample container and information about the patient sample.

At block 1606, the doctor or medical professional saves the sample information to the NFC tag, substantially as described above with respect to block 414 of FIG. 4.

Examples according to this disclosure may reduce a number of unusable samples during the course of a clinical trial (or other process) due to samples becoming disconnected from information regarding the samples. Loose samples may ordinarily be unusable because their identities, or even which trial they are associated with, are unknown. Further, processing instructions transported separately from the sample, or special instructions regarding a particular sample may become disassociated from the sample during transport. For example, multiple different unrelated sample containers may arrive together in a single shipping container. By storing sample information electronically on the sample container itself, it can reduce the chances of samples being processed incorrectly or simply discarded without processing due to lost instructions or other information. Thus, systems and methods according to this disclosure may improve the efficiency of various testing scenarios, such as in clinical trials or other laboratory testing scenarios.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered. Accordingly, the above description does not bind the scope of the claims.

The use of “configured to” herein is meant as open and inclusive language that does not foreclose devices configured to perform additional tasks or steps. Additionally, the use of “based on” is meant to be open and inclusive, in that a process, step, calculation, or other action “based on” one or more recited conditions or values may, in practice, be based on additional conditions or values beyond those recited.

While the present subject matter has been described in detail with respect to specific examples thereof, it will be appreciated that those skilled in the art, upon attaining an understanding of the foregoing, may readily produce alterations to, variations of, and equivalents to such examples. Accordingly, it should be understood that the present disclosure has been presented for purposes of example rather than limitation, and does not preclude inclusion of such modifications, variations and/or additions to the present subject matter as would be readily apparent to one of ordinary skill in the art.

While some examples of methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A patient sample management system comprising:
one or more sample containers, each of the sample containers defining an interior cavity and an opening providing access to the interior cavity;
one or more electronic writable memories, each electronic writeable memory coupled to one of the sample containers, each electronic writable memory configured to wirelessly receive information from a computing device and to store the received information; and
a computing device comprising:
a non-transitory computer-readable medium;
a wireless proximity communications device configured to:
establish a wireless communication link with one of the electronic writable memories,
read information stored on the one of the electronic writable memories, and
store information on the electronic writable memory; and
a processor in communication with the wireless proximity communications device and the non-transitory computer-readable medium, the processor configured to execute processor-executable program code stored in the non-transitory computer-readable medium to:
obtain sample information associated with a biological sample deposited within one of the sample containers;
transmit the sample information to the wireless proximity communications device; and
transmit a command to the wireless proximity communication device to store the sample information on one of the electronic writable memories.

2. The patient sample management system of claim 1, further comprising:
a database comprising data records associated with one or more biological samples deposited in the one or more sample containers; and
a remote computing device in communication with the database, the remote computing device configured to communicate with the computing device to maintain the sample information in the database.

3. The patient sample management system of claim 2, wherein the remote computing device is further configured to:
receive a request for the sample information from the computing device,
obtain the sample information from the database, and
transmit the sample information to the remote computing device.

4. The patient sample management system of claim 2, wherein the remote computing device is further configured to:
receive the sample information from the computing device, and
store the sample information in the database.

5. The patient sample management system of claim 1, wherein the processor is further configured to execute processor-executable program code stored in the non-transitory computer-readable medium to:
transmit a command to the wireless proximity communication device to read sample information stored on the one of the electronic writable memories; and
receive, in response to the command, the sample information stored on the one of the electronic writable memories.

6. The patient sample management system of claim 1, wherein the electronic writable memories are configured to store one or more of a time stamp, shipping information, clinical trial identification information, instructions for drawing or handling a biological sample, non-personally identifiable patient information, instructions for additional processing for the biological sample, instructions for discarding the biological sample, instructions for testing the biological sample, or test results for the biological sample.

7. The patient sample management system of claim 1, wherein one or more of the electronic writable memories comprises a secure near-field communication tag.

8. The patient sample management system of claim 1, wherein the a computing device further comprises a display, the processor is further configured to execute processor-executable program code stored in the non-transitory computer-readable medium to:
display a graphical user interface (“GUI”), the GUI configured to:
receive the sample information via the GUI; and
provide a user interface element to transmit the sample information to an electronic writable memory.

9. The patient sample management system of claim 8, wherein the GUI is further configured to:
receive a request to read the sample information from an electronic writable memory; and
display the sample information received from the electronic writable memory.

10. The patient sample management system of claim 8, wherein the GUI is further configured to:
provide a second user interface element to confirm compliance with processing instructions for a biological sample.

11. A method comprising:
requesting, by a computing device comprising a wireless proximity communications device, sample information associated with a biological sample deposited within a sample container, the sample container having an electronic writable memory configured to wirelessly receive information from a computing device and to store the received information;
receiving, in response to the request, the sample information;
moving the computing device proximate to the electronic writable memory and establishing a communications link between the computing device and the electronic writable memory;
transmitting, via the communications link, the sample information to the electronic writable memory; and
storing the sample information on the electronic writable memory.

12. The method of claim 11, wherein the sample information is received from a user interface on the computing device.

13. The method of claim 11, wherein the sample information is received from a remote computing device.

14. The method of claim 11, wherein the electronic writable memory comprises a secure near-field communication tag, the communications link comprises a secure communications link, and further comprising receiving a password associated with the electronic writable memory.

15. The method of claim 11, wherein the sample information comprises one or more of a time stamp, shipping information, clinical trial identification information, instructions for drawing or handling a biological sample, non-personally identifiable patient information, instructions for additional processing for the biological sample, instructions for discarding the biological sample, instructions for testing the biological sample, or test results for the biological sample.

16. A method comprising:
receiving a sample container containing a biological sample, the sample container having an electronic writable memory configured to wirelessly receive information from a computing device and to store the received information;
moving a computing device proximate to the electronic writable memory, the computing device comprising a wireless proximity communications device, and establishing a communications link between the computing device and the electronic writable memory using the wireless proximity communications device;
receiving, via the communications link, the sample information from the electronic writable memory; and
processing the biological sample based on the sample information.

17. The method of claim 16, wherein processing the biological sample comprises performing at least one test of the biological sample.

18. The method of claim 16, wherein the electronic writable memory comprises a secure near-field communication tag, the communications link comprises a secure communications link, and further comprising receiving a password associated with the electronic writable memory.

19. A patient sample container comprising:
a biological sample container defining an interior cavity and an opening providing access to the interior cavity; and
an electronic writable memory coupled to the biological sample container, the electronic writable memory configured to wirelessly receive information from a remote computing device and to store the received information.

20. The patient sample container of claim 19, wherein the electronic writable memory comprises a secure near-field communication tag.
